(19) United States
(12) Patent Application Publication
(10) Pub. No.: US 2008/0124089 A1
(43) Pub. Date: May 29, 2008

(54) Optical Transceiver And Method For Coating The Same

(76) Inventors: Yoshiaki Ishigami, Hitachi (JP); Yoshinori Sunaga, Hitachinaka (JP); Izumi Fukasaku, Hitachi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/665,453

(22) PCT Filed: Oct. 12, 2005
(86) PCT No.: PCT/JP05/18793

§ 371 Date: Apr. 16, 2007

(30) Foreign Application Priority Data
Oct. 14, 2004 (JP) 2004-299816
Jan. 13, 2005 (JP) 2005-006436

(51) Int. Cl. H04B 10/00

(52) U.S. Cl. 398/139

(57) ABSTRACT

An optical transceiver comprising a metal case, and an insulating film at least partially covering a case projecting from a host device when the optical transceiver is set in the host device. A method for coating the optical transceiver to be set in the host device comprises steps for sticking a tape to the receptacle portion with a silicone film of the case projecting from the host device when the optical transceiver is set in the host device, for stripping the tape after masking the part other than the receptacle portion, and for immersing the case entirely in a cation electrodeposition paint tank to form an insulating film composed of a cation electrodeposition coating film at the receptacle portion.

### TECHNICAL FIELD

The invention relates to an optical transceiver attached to a host device.

### BACKGROUND ART

FIG. 8 shows a conventional pluggable type optical transceiver (or an optical transceiver module) 81. The optical transceiver 81 is structured such that an optical fiber connector with an optical fiber as a transmission line can be inserted into or removed from a receptacle portion 83 formed at one end of a chassis (or a package) 82 thereof.

The optical transceiver 81 can be inserted into or removed from a host device 21 as an external device. The receptacle portion 83 is a part of the chassis 82 and projects from the host device when the optical transceiver 81 is attached to the host device 21. The chassis 82 can be formed of metal or nonmetal (e.g., plastic).

Related arts to the present invention are as follows.

Patent Literature 1: U.S. Pat. No. 5,864,468

Patent Literature 2: U.S. Pat. No. 6,439,918

### DISCLOSURE OF THE INVENTION

### Problems to be Solved by the Invention

However, when the chassis 82 is formed of metal, the optical transceiver 81 may cause a communication error (e.g., transmission error) due to an electrical discharge occurred when a charged person touches the receptacle portion 83 with his hand, although it has a good heat radiation property.

On the other hand, when the chassis 82 is formed of nonmetal, the heat radiation property is reduced although the above problem, i.e., the communication error due to the electrical discharge, can be prevented.

The chassis 82 may be provided with a connection member to have a common ground with the host device. In this case, it is necessary to secure an electrical connection between the body of the chassis and the host device.

It is an object of the invention to provide an optical transceiver that can prevent the transmission error due to the electrical discharge etc. and that can secure the heat radiation property, along with a method for coating the transceiver.

It is another object of the invention to provide an optical transceiver that can secure electrical connection to provide a common ground with the host device, along with a method for coating the transceiver.

### Means for Solving the Problems

According to one aspect of the invention, an optical transceiver comprises:

a chassis comprising a metal; and

an insulating film covering at least a portion of the chassis to project from a host device when the optical transceiver is attached to the host device.

In the above invention, the following modifications and changes can be made.

(i) A whole of the chassis is covered with the insulating film.

(ii) The insulating film is formed by electrodeposition-coating a coating material containing a resin.

(iii) The electrodeposition coating is a cationic electrodeposition coating.

(iv) The insulating film comprises a thickness of 5 to 50 μm.

(v) The insulating film comprises a fluorine-based resin.

(vi) The chassis comprises a transceiver chassis housing a transceiver body, and a cover fixed to the transceiver chassis and covering the transceiver body,

the transceiver chassis comprises a projection formed at a portion except a receptacle portion of the transceiver chassis to project from the host device when the transceiver chassis is attached to the host device, and

the cover comprises a hole to be fitted to the projection.

(vii) The chassis comprises a transceiver chassis housing a transceiver body, and a cover fixed to the transceiver chassis and covering the transceiver body,

the transceiver chassis comprises a hole formed at a portion except a receptacle portion of the transceiver chassis to project from the host device when the transceiver chassis is attached to the host device, and

the cover comprises a projection to be fitted to the hole.

(viii) The chassis comprises a transceiver chassis housing a transceiver body, and a cover fixed to the transceiver chassis and covering the transceiver body, and

the cover comprises a plate spring biasing a portion except a receptacle portion of the transceiver chassis to project from the host device when the transceiver chassis is attached to the host device.

According to another aspect of the invention, a method for coating the optical transceiver as mentioned in (vi) comprises the steps of:

masking at least the projection; and

soaking a whole of the transceiver chassis in a cationic electrodeposition coating material bath to form an insulating film comprising a cationic electrodeposition coating film at the receptacle portion.

According to another aspect of the invention, a method for coating the optical transceiver as mentioned in (vii) comprises the steps of:

masking at least the hole; and

soaking a whole of the transceiver chassis in a cationic electrodeposition coating material bath to form an insulating film comprising a cationic electrodeposition coating film at the receptacle portion.

According to another aspect of the invention, a method for coating the optical transceiver as mentioned in (viii) comprises the steps of:

masking at least a portion of the transceiver chassis biased by the plate spring; and

soaking a whole of the transceiver chassis in a cationic electrodeposition coating material bath to form an insulating film comprising a cationic electrodeposition coating film at the receptacle portion.

According to another aspect of the invention, a method for coating an optical transceiver attached to a host device comprises the steps of:

masking a portion except a receptacle portion of a chassis to project from the host device when the optical transceiver is attached to the host device; and

soaking a whole of the chassis in a cationic electrodeposition coating material bath to form an insulating film comprising a cationic electrodeposition coating film at the receptacle portion.

In the above invention, the following modifications and changes can be made.

(ix) The portion except the receptacle portion is masked with a silicone film.

(x) The portion except the receptacle portion is soaked in a silicone liquid bath to form a silicone film at the portion except the receptacle portion.

According to another aspect of the invention, a method for coating an optical transceiver attached to a host device comprises the steps of:

attaching a tape to a receptacle portion of a chassis to project from the host device when the optical transceiver is attached to the host device;

masking a portion except the receptacle portion with a silicone film;

removing the tape; and

soaking a whole of the chassis in a cationic electrodeposition coating material bath to form an insulating film comprising a cationic electrodeposition coating film at the receptacle portion.

The present application is based on Japanese patent application Nos. 2004-299816 and 2005-006436, the entire contents of which are incorporated herein by reference.

### BRIEF DESCRIPTION OF THE DRAWINGS

FIG. 1 is an exploded perspective view showing an optical transceiver in a preferred embodiment according to the invention.

FIG. 2 is a perspective view showing a host device to which the optical transceiver in FIG. 1 is attached.

FIG. 3 is a schematic diagram for explaining a cationic electrodeposition coating.

FIGS. 4A and 4B are a schematic diagram for explaining an example of a method for coating the optical transceiver in FIG. 1.

FIG. 5 is a schematic diagram for explaining an example of a method for coating the optical transceiver shown in FIG. 1.

FIG. 6 is an exploded perspective view showing an optical transceiver in another preferred embodiment according to the invention.

FIG. 7 is a perspective view showing a modified example (i.e., a main portion of a cover) of the optical transceiver shown in FIG. 6.

FIG. 8 is a perspective view showing a host device to which the conventional optical transceiver is attached.

### BEST MODE FOR CARRYING OUT THE INVENTION

Preferred embodiments of the invention will be explained below referring to the accompanying drawings.

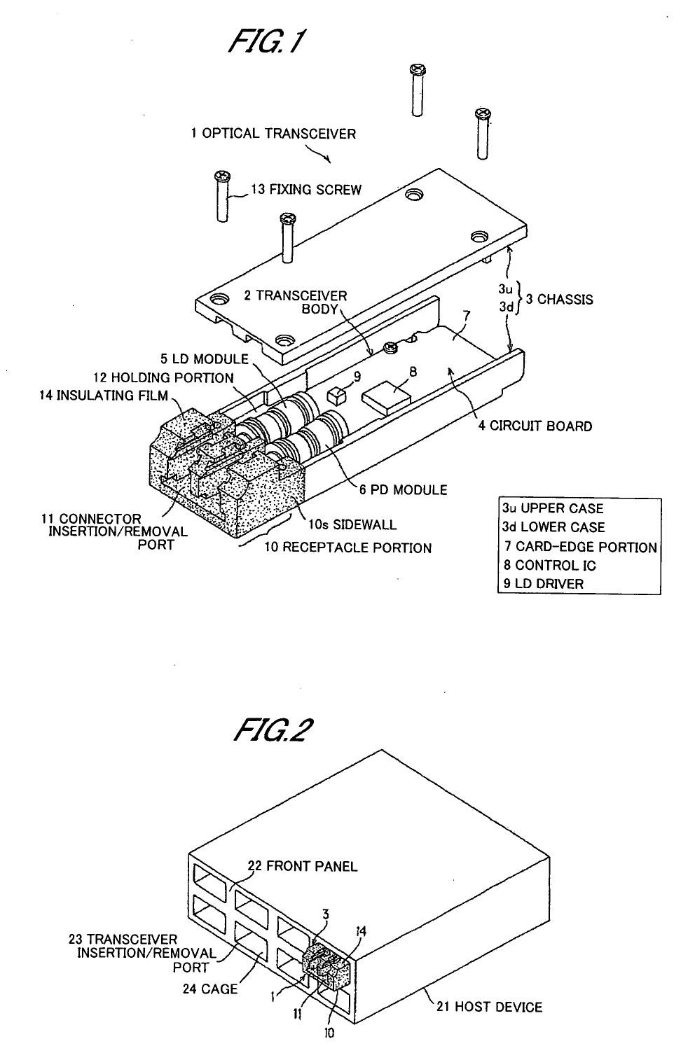

FIG. 1 shows an optical transceiver in a preferred embodiment according to the invention.

As shown in FIG. 1, the optical transceiver 1 according to the embodiment is a pluggable type optical transceiver similar to the optical transceiver 81 as shown in FIG. 8. The optical transceiver 1 comprises a transceiver body 2 and a chassis (or a package) 3 to house the transceiver body 2.

The transceiver body 2 is constructed such that an LD (=a semiconductor laser diode) module 5 as a light transmission module to transmit an optical signal and a PD (=a photo diode) module 6 as a light reception module to receive an optical signal are each fixed by soldering to one end of a circuit board 4 thereof.

The LD module 5 is composed such that a collar to adjust an optical axis thereof and a ferrule used to optically couple an LD element module to an optical fiber connector (not shown), which are attached to the LD element module with an LD element. The optical fiber connector is provided with an optical fiber as a transmission line.

The PD module 6 has the same composition as the LD module 5.

At the other end of the circuit board 4, a card-edge portion 7 is formed which is adapted to be fitted to a card-edge connector of the host device described later in FIG. 2 as an external device. The card-edge portion 7 is provided with a connecting terminal (not shown) to electrically connect the circuit board 4 and the host device.

The circuit board 4 is provided with a wiring pattern and a terminal, and electronic components are mounted thereon which include a control IC 8 to control a signal to be transmitted or received from the LD module 5 and the PD module 6, an LD driver 9 to drive the LD element, and an amplifier to amplify a signal from the PD module 6.

The chassis 3 comprises a nearly box-shaped lower case 3d as a chassis body whose upper most side and backside (on the other end side) are opened and a nearly plate-shaped upper case (or a lid) 3u which covers almost the opened upper side of the lower case 3d.

The lower case 3d and the upper case 3u are, for example, formed together by die-casting a metal with a high heat radiation property such as SUS, Zn and Al. Alternatively, the lower case 3d and the upper case 3u may be formed by cutting the metal with a high heat radiation property such as SUS, Zn and Al.

The receptacle portion 10 formed at one end of the lower case 3d is provided with two connector insertion/removal ports 11 which are formed in parallel and through which the optical fiber connector can be inserted into or removed from the receptacle portion 10. The lower case 3d is, on the opposite side to the connector insertion/removal ports 11, provided with a holding portion 12 to hold the LD module 5 and the PD module 6. A pullout lever (not shown) for pulling out the optical transceiver 1 from the host device may be rotatably attached to both sidewalls 10s of the receptacle portion 10. The other end of the lower case 3d is opened at the lower side as well as the upper side and the backside thereof.

The optical transceiver 1 is assembled such that the transceiver body 2 is housed in the lower case 3d, the lower case 3d is covered with the upper case 3u, and thereafter the upper case 3u is screw-fixed to the lower case 3d by using four fixing screws 13.

FIG. 2 shows the host device 21 with the optical transceiver 1 in FIG. 1 attached thereto.

As shown in FIG. 2, the host device 21 is, on a front panel 22 thereof, provided with a plurality of transceiver insertion/removal ports 23 through which to insert or remove the optical transceiver 1. Cages 24 are formed in the host device 21 corresponding to the respective transceiver insertion/removal ports 23 to allow the optical transceiver 1 except the receptacle portion 10 to be inserted into the host device 21. At the back of the inside of the cages 24, a card-edge connector is installed to which the card-edge portion 7 in FIG. 1 can be fitted.

The host device 21 includes, for example, a communication device such as a switching hub and a media converter.

In operation, the optical transceiver 1 is electrically connected to the host device 21 (in the state as shown in FIG. 2) by being inserted into the host device 21, and is optically connected to the optical fiber by inserting the optical fiber connector into the connector insertion/removal port 11.

The receptacle portion 10 is a portion of the chassis 3 (in detail, the lower case 3d) to project from the host device 21 when the optical transceiver 1 is attached to the host device 21. As shown in FIGS. 1 and 2, the optical transceiver 1 of this embodiment has the receptacle portion 10 covered with an insulating film 14.

The insulating film 14 is formed by electrodeposition coating of a coating material containing a resin. Although the electrodeposition coating includes a cationic (positive ion) electrodeposition coating and an anionic (negative ion) electrodeposition coating, the insulating film 14 of the embodiment is formed by the cationic electrodeposition coating.

The insulating film 14 has a thickness of 5 to 50 μm. If the thickness is less than 5 μm, a problem arises that sufficient insulation property can be unsecured. On the other hand, if the thickness is more than 50 μm, a problem arises that dimensional accuracy of the receptacle portion 10 can be unsatisfied. In addition, if the thickness falls within 50 μm, sufficient heat radiation property of the optical transceiver 1 can be also secured.

The receptacle portion 10 demands severe dimensional accuracy which is ±10 μm. Therefore, it is preferred that the insulating film 14 has a thickness of 15 to 40 μm.

Any resins can be used for the insulating film 14 if the resins comprise high insulation property. In this embodiment, the insulating film 14 is formed of a fluorine series resin.

The fluorine series resin is excellent in cut-through resistance to allow the easy formation of the thin insulating film 14, and it is also excellent in insulation property, mechanical strength and heat resistance.

The cationic electrodeposition coating will be briefly explained below with reference to FIG. 3.

As shown in FIG. 3, the cationic electrodeposition coating is a coating method conducted such that a coated object 32 is soaked in a coating material bath (or tank) 31 filled with an alkaline coating material p containing a conducive water-soluble (or water dispersible) resin, a direct-current electricity is fed therethrough to electrically deposit the coating material p to the coated object 32, and the deposited coating material is hardened to form a coating film.

The cationic electrodeposition coating can be likened to plating of a polymer. The coating procedure includes depositing a coating material particle (i.e., ionic polymer) 33 on the surface of the coated object 32 (where the deposit is water-insoluble) by using the electrolysis of water, taking out the object 32, washing it in water (so as to remove the coating material being not deposited and adhered thereto), and baking it to obtain the cross-linked coated film. The coating material bath 31 is filled with the water-soluble electrodeposition coating material p which is water-diluted to a relatively low concentration. By feeding negative electrical current into the conductive coated object 32 (where the coating material particles 33 are charged positively), the water-insoluble coating film is uniformly deposited on the surface of the coated object 32.

In this embodiment, at first, the receptacle portion 10 of the lower case 3d explained in FIG. 1 as the coated object 32 is soaked in the coating material bath 31 filled with the coating material p, and a negative direct-current voltage is applied to the lower case 3d as one electrode as well as applying a positive direct-current voltage to the other electrode 34 soaked in the coating material bath 31 to allow the coating material particles 33 to be deposited on the receptacle portion 10.

After that, the lower case 3d is taken out, the lower case 3d is washed in water to remove the coating material particles 33 being not deposited, and the deposited coating material particles 33 is baked (e.g., at a baking temperature of 180° C.) to obtain a hardened coating film. As a result, the insulating film 14 as shown in FIG. 1 is formed on the receptacle portion 10.

The cationic electrodeposition coating has advantages: (1) The coating process can be automated and simplified; (2) Loss of the coating material can be almost eliminated; (3) Uniform coating film can be obtained (where a desired film thickness can be easily obtained by adjusting the amount of electricity); (4) The coating film has a good adhesive property (even a hidden interior thereof can be coated). The coating film can be deposited even at a portion never before coatable and at a portion difficult to supply the coating material. Thus, corrosion resistance in a complex construction can be enhanced; (5) There is no danger of fire hazards since the coating material is water-based; (6) It is low in and excellent in environmental responsiveness because of being low-pollution; and (7) A coating film with more excellent corrosion resistance than the anionic electrodeposition coating can be obtained (since the obtained product is charged negatively).

The operation of the embodiment will be explained below.

The optical transceiver 1 has good heat radiation property since the chassis 3 is formed of a metal. The receptacle portion 10 (being a portion of the lower case 3d) to project from the host device 21 when the optical transceiver 1 is inserted in the host device 21 is covered with the insulating film 14. Therefore, the optical transceiver 1 can ensure good heat radiation property, and simultaneously can prevent an electrostatic discharge (ESD) by virtue of the insulating film 14 even when an electrically-charged person touches the optical transceiver 1 inserted in the host device 21. As a result, communication error (i.e., transmission error) can be prevented.

The insulating film 14 with a uniform and precise film thickness can be formed by virtue of the cationic electrodeposition coating. Therefore, the optical fiber connector can be surely removed from the connector insertion/removal port 11 even when the insulating film 14 is formed on the receptacle portion 10 that demands a severe dimensional accuracy.

When the receptacle portion 10 is formed of a metal like the conventional one, a connector portion of the optical fiber connector is generally formed of a metal so that a dust (a metallic dust) may be caused at the connection part of the optical fiber connector and the LD module 5 or the PD module 6 and the transmission loss may be increased. However, in the optical transceiver 1 of the embodiment, the receptacle portion 10 is covered with the insulating film 14 formed of a resin, so that a skid resistance of the optical fiber connector to the connector insertion/removal port 11 can be reduced and the dust can be reduced which may be generated at the connection part due to a wear of the optical fiber connector or the connector insertion/removal port 11. Thus, increase in transmission loss can be prevented.

Although in the above embodiment, the receptacle portion 10 of the lower case 3d is covered with the insulating film 14, the entire lower case 3d or chassis 3 can be covered with the insulating film 14. In this case, in the cationic electrodeposition coating as shown in FIG. 3, the insulating film 14 can be easily formed by soaking the lower case 3d or the upper case 3u in the coating material bath 31 filled with the coating material p.

Another method for coating the optical transceiver 1 will be explained below.

In the example shown in FIG. 3, in coating the receptacle portion 10 by the cationic electrodeposition coating, the receptacle portion 10 is soaked in the coating material p filled in the coating material bath 31. However, it is difficult to accurately coat only the receptacle portion 10 since the fluid level can easily fluctuate in case of using the large coating material bath 31.

On the other hand, if the whole or the majority of the lower case 3d is coated by the cationic electrodeposition coating, when the optical transceiver is inserted in the host device, there is a possibility that electrical connection to provide a common ground between the lower case 3d and the host side cannot be achieved. As a result, the optical transceiver gets into a situation where it is electrically set off from the ground electrical potential.

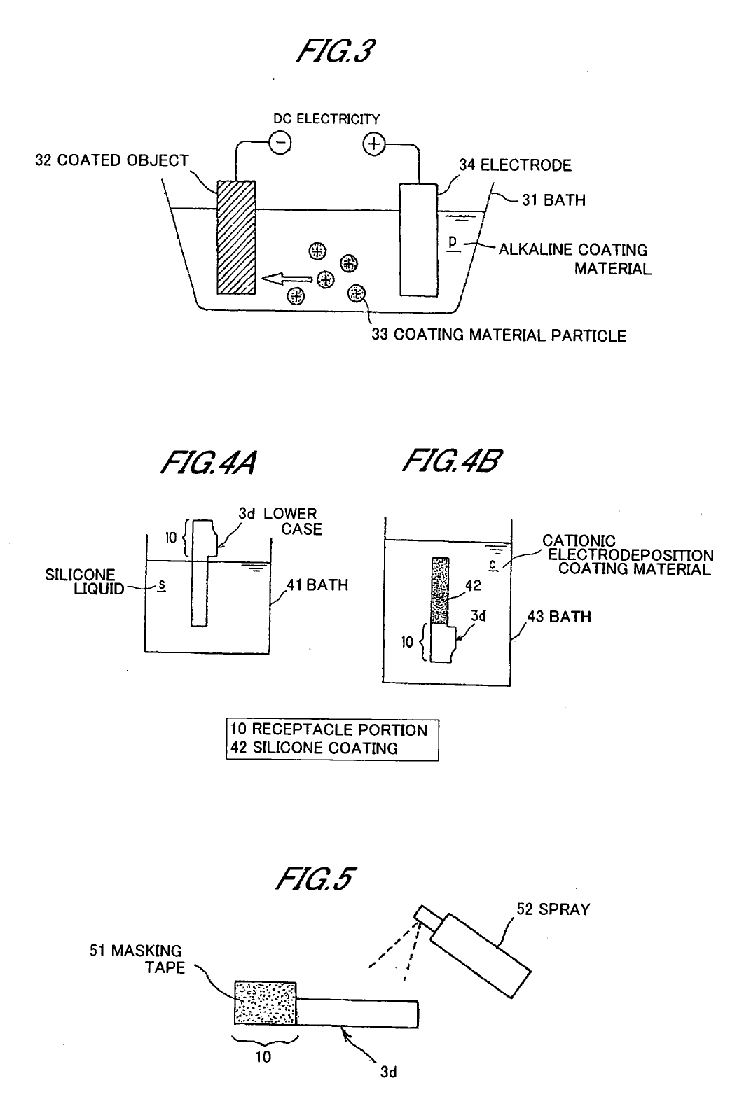

In view of this, at first, a portion except the receptacle portion 10 of the lower case 3d is masked. For example, as shown in FIG. 4A, the portion except the receptacle portion 10 of the lower case 3d is soaked in a silicone liquid s containing a silicone resin as a masking agent in a silicone liquid bath 41. Then, the lower case 3d is taken out and the silicone liquid s is dried, so that a silicone coating 42 as a masking film is formed on the portion except the receptacle portion 10.

After the masking, as shown in FIG. 4B, the lower case 3d with the silicone coat 42 formed on the portion except the receptacle portion 10 is entirely soaked in a cationic electrodeposition coating material (i.e., a cationic electrodeposition coating liquid) c (corresponding to the coating material p as shown in FIG. 3) in a cationic electrodeposition coating material bath 43 (corresponding to the coating material bath 31 as shown in FIG. 3). In the same way as shown in FIG. 3, the insulating film 14 formed of the cationic electrodeposition coating film (See FIG. 1) is formed on the portion except the receptacle portion 10.

In the cationic electrodeposition coating, it is only necessary to soak the entire lower case 3d after the masking in the cationic electrodeposition coating material bath 43, so that it is not affected by the fluctuation of the fluid level. Therefore, it becomes easy to coat only the receptacle portion 10.

Generally, there is a tendency in the cationic electrodeposition coating material bath 43 that the middle portion of the fluid bath is better in adhesive property the cationic electrodeposition coating film than the vicinity of the fluid surface. Therefore, the adhesive property of the cationic electrodeposition coating film can be enhanced more by the method of soaking the entire lower case 3d after the masking in the cationic electrodeposition coating material bath 43 than by the method of soaking only the receptacle portion 10 directly in the cationic electrodeposition coating material.

As mentioned above, according to the coating method of the embodiment, only the receptacle portion 10 can be coated with accuracy and easiness by the cationic electrodeposition coating.

Further, the cationic electrodeposition coating is conducted only to the receptacle portion 10 so that, when the optical transceiver 1 is inserted in the host device 21 as shown in FIG. 2, the electrical connection to provide a common ground between the lower case 3d and the host side can be surely achieved.

The silicone coating used for the masking can sufficiently endure the baking at the cationic electrodeposition coating (at baking temperature of 180° C.), and can be easily removed by peeling or dissolving by using a solvent after the cationic electrodeposition coating.

When a silicone resin with low adhesive property as a masking agent is used, the entire masking film can be easily peeled off by forming a cut line at one site of the masking film after the mask coating. However, there is a possibility that the masking film is peeled during the cationic electrodeposition coating and then the cationic electrodeposition coating material penetrates the peeled site, so that accuracy in border line of the coating may decrease. Therefore, in the case that the accuracy in border line of the coating is particularly required, it is preferred that a silicone resin with high adhesive property is used as the masking agent.

In this case, a silicone resin solvent can be used to remove the masking agent after the coating since the masking film is difficult to peel. The silicone resin solvent preferably includes a hydrocarbon-based solvent mainly containing n-octane. The solvent can easily dissolve the silicone resin (i.e., the masking agent), and does not dissolve an epoxy-based resin and a fluorine-based resin which are a main component of the cationic electrodeposition coating film.

When a more accurate masking is required, for example, as shown in FIG. 5, at first, a masking tape 51 is attached to the receptacle portion 10 of the lower case 3d. Then, the silicone liquid is sprayed on the portion except the receptacle portion 10 by a spray 52 to mask the portion except the receptacle portion 10 with the silicone film. After the masking, the masking tape 51 attached to the receptacle portion 10 is peeled, the step shown in FIG. 4B is conducted such that the insulating film 14 (See FIG. 1) formed of the cationic electrodeposition coating film is formed on the receptacle portion 10 in the same way as shown in FIG. 3.

In the above coating method, the silicone film for the masking is formed after the masking tape 51 is attached so that the portion except the receptacle portion 10 can be masked more accurately than the method of directly forming the silicone film for the masking as shown in FIG. 4A.

Another embodiment according to the invention will be explained below.

FIG. 6 shows an optical transceiver in the other preferred embodiment according to the invention.

As shown in FIG. 6, an optical transceiver 61 is a pluggable type optical transceiver similar to the optical transceiver 81 shown in FIG. 8.

The optical transceiver 61 comprises a transceiver body 2, a transceiver chassis 63 as a chassis body to which the transceiver body 2 is housed, and a cover 64 being fixed to the transceiver chassis 63 and covering the entire transceiver body 2 (covering the entire transceiver chassis 63 which is fitted thereto). The chassis comprises the transceiver chassis 63 and the cover 64.

The transceiver chassis 63 is, for example, formed together by die-casting a metal with high heat radiation property such as Zn, Al. Also the transceiver chassis 63 may be formed by cutting the metal with the high heat radiation property such as Zn, Al. The transceiver chassis 63 is opened downwardly at one end opposite to the receptacle portion 10 and is nearly L-shaped on a side face thereof.

The receptacle portion 60 formed at one end of the transceiver chassis 63 is provided with two connector insertion/removal ports 62 formed in parallel, into or from which the optical fiber connector can be inserted or removed. The transceiver chassis 63 is, on the other side, provided with a housing portion 65 being nearly plate-shaped to house the transceiver body 2. The housing portion 65 is, at one end, provided with a leg portion 66 on which the circuit board 4 is disposed, and a screw 67 is threaded into the leg portion 66 through a concave notch formed in the circuit board 4.

The cover 64 is formed of a metal with a high heat radiation property such as SUS, Zn and Al is formed nearly cylindrical. The cover 64 is, at its one end, opened downwardly. The cover 64 is provided with a connection member (not shown) to provide the common ground between the optical transceiver 61 and the host device 21 as shown in FIG. 2 when the optical transceiver 61 is inserted in the host device 21. Further, the cover 64 is formed by folding a metal plate, and a fine gap 64g is formed in the longitudinal direction near the middle of an upper surface 64u of the cover 64.

Similarly to the optical transceiver 1 as shown in FIG. 1, the optical transceiver 61 is covered with the insulating film 14 at the receptacle portion 60 to project from the host device 21 when it is inserted in the host device 21. The insulating film 14 can be formed by the methods explained with reference to FIGS. 3, 4A, 4B and 5. The optical transceiver 61 can also achieve the same operation and effect as those of the optical transceiver 1.

Further, the transceiver chassis 63 is provided with two projections 68 at a portion except the receptacle portion 60 on an upper surface 63u thereof neighboring the receptacle portion 60, and the cover 64 is provided with holes 69 to be fitted to the projections 68 on an upper surface 64u of the cover 64.

The optical transceiver 61 is assembled by housing the transceiver body 2 in the transceiver chassis 63, covering it with the cover 64 by sliding it from the other end of the transceiver chassis 63, and fixing the cover 64 to the transceiver chassis 63.

In this case, the projections 68 of the transceiver chassis 63 are fitted into the holes 69 of the cover, so that the electrical connection between the transceiver chassis 63 and the cover 64 can be surely obtained. When the optical transceiver 61 is inserted in the host device 21 shown in FIG. 2, the electrical connection between the transceiver chassis 63 and the host device 21 can be achieved by the connection member (not shown) of the cover 64. Thus, the electrical connection to provide the common ground between the transceiver chassis 63 and the host side can be more surely achieved, as compared to the case that the projections 68 and the holes 69 are not formed.

Further, by fitting the projections 68 of the transceiver chassis 63 into the holes 69 of the cover 64, the gap 64g of the cover 64 can be prevented from being enlarged when the optical transceiver 61 is inserted into or removed from the host device 21 as shown in FIG. 2.

Furthermore, although the insulating film 14 is preferably formed only on the receptacle portion 60 by the coating, even if the coating in the optical transceiver 61 is conducted at such a low accuracy that the insulating film 14 is formed at a portion except the receptacle portion 60, the electrical connection to provide the common ground with the host side can be ensured by virtue of the projections 68 and the holes 69.

Alternatively, projections can be formed on a side surface of the portion except the receptacle portion 60 of the transceiver chassis 63 and holes to be fitted thereto can be formed on a side surface of the cover 64.

A method of coating the optical transceiver 61 can be conducted by masking at least the projections 68 with the silicone film by using the coating method explained with reference to FIG. 4A or FIG. 5, and then forming the insulating film 14 on the receptacle portion 60 by using the coating method explained with reference to FIG. 5.

On the other hand, when the insulating film 14 is formed only on the receptacle portion 60 by masking all portions except the receptacle portion 60, the insulating film 14 can be prevented from being damaged by the cover 64 when covering the transceiver chassis 63 with the cover 64. Further, as a contact area between the transceiver chassis 63 and the cover 64 increases, it is further preferable in achieving the electrical connection to provide the common ground with the host side.

Alternatively, holes may be formed on the portion except the receptacle portion 60 of the transceiver chassis 63, and projections to be fitted thereto may be formed on the lower surface of the cover 64. In this case, a coating method can be conducted by masking at least the holes with the silicone film by using the coating method explained with reference to FIG. 4A or FIG. 5, and then forming the insulating film 14 on the receptacle portion 60 by using the coating method explained with reference to FIG. 5.

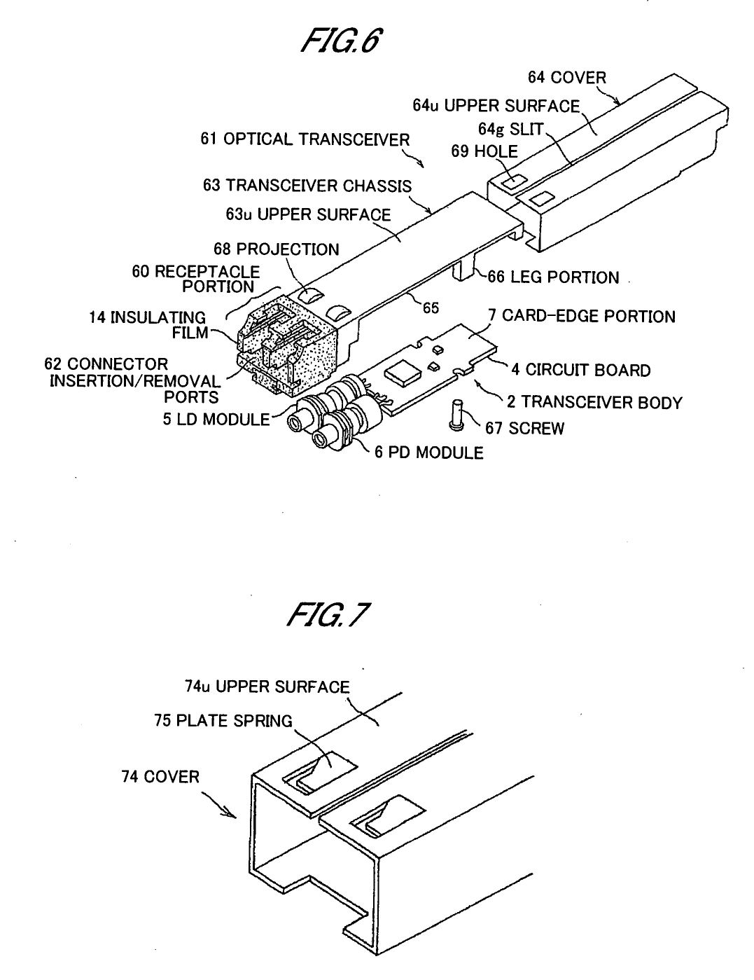

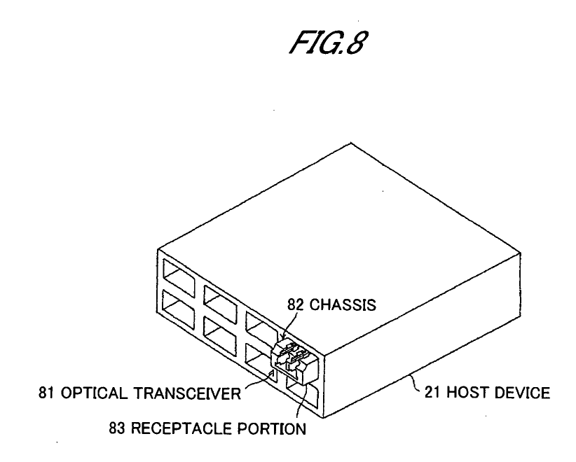

FIG. 7 shows a modified example (a major portion of a cover 74) of the optical transceiver 61 as shown in FIG. 6.

As shown in FIG. 7, two plate springs 75 to bias downward the portion except the receptacle portion 60 of the transceiver chassis are formed on an upper surface 74u of the cover 74.

The plate spring 75 is formed integrally with the cover 74 by making a nearly U-shaped cut in the upper surface 74u of the cover 74, and then bending downwardly the cut portion. Thus, a part of the cover 74 is used as the plate spring 75.

The transceiver chassis used in the modified example has the same structure as the transceiver chassis 63 except for the projections 68 as shown in FIG. 6. In this case, the coating method can be conducted by masking at least a portion of the transceiver chassis to be biased by the plate spring 75 with the silicone film by using the coating method explained with reference to FIG. 4A or FIG. 5, and then forming the insulating film 14 on the receptacle portion 60 by using the coating method explained with reference to FIG. 4. Thus, the insulating film 14 is controlled not to be formed at least at the portion of the transceiver chassis to be biased by the plate spring 75.

In the modified example as described above, when the cover 74 is fixed to the transceiver chassis, the cover 74 surely contacts the transceiver chassis since the plate springs 75 bias downwardly the upper surface of the transceiver chassis. Therefore, similarly to the optical transceiver 61 as shown in FIG. 6, the electrical connection between the transceiver chassis and the cover 74 can be surely achieved and the electrical connection to provide the common ground between the transceiver chassis the host side can be more surely achieved.

Alternatively, plate springs to bias inwardly the side surface of the portion except the receptacle portion 60 of the transceiver chassis may be formed on the side surface of the cover 74.

Further, another modified example may be constructed such that an inside dimension of the cover to an outside dimension of the transceiver chassis is formed smaller than usual so as to surely contact the cover with the transceiver chassis.

### INDUSTRIAL APPLICABILITY

The optical transceiver and the method for coating the optical transceiver according to the invention can prevent the transmission error due to the electrical discharge etc. as well as securing the heat radiation property.

Further, the optical transceiver and the method for coating the optical transceiver according to the invention can secure the electrical connection to provide a common ground with the host device.

1. An optical transceiver, comprising:
a chassis comprising a metal; and
an insulating film covering at least a portion of the chassis to project from a host device when the optical transceiver is attached to the host device.

2. The optical transceiver according to claim 1, wherein: a whole of the chassis is covered with the insulating film.

3. The optical transceiver according to claim 1, wherein:
the insulating film is formed by electrodeposition coating a coating material containing a resin.

4. The optical transceiver according to claim 3, wherein: the electrodeposition coating is a cationic electrodeposition coating.

5. The optical transceiver according to claim 1, wherein:
the insulating film comprises a thickness of 5 to 50 μm.

6. The optical transceiver according to claim 1, wherein:
the insulating film comprises a fluorine-based resin.

7. The optical transceiver according to claim 1, wherein:
the chassis comprises a transceiver chassis housing a transceiver body, and a cover fixed to the transceiver chassis and covering the transceiver body,
the transceiver chassis comprises a projection formed at a portion except a receptacle portion of the transceiver chassis to project from the host device when the transceiver chassis is attached to the host device, and
the cover comprises a hole to be fitted to the projection.

8. The optical transceiver according to claim 1, wherein:
the chassis comprises a transceiver chassis housing a transceiver body, and a cover fixed to the transceiver chassis and covering the transceiver body,
the transceiver chassis comprises a hole formed at a portion except a receptacle portion of the transceiver chassis to project from the host device when the transceiver chassis is attached to the host device, and
the cover comprises a projection to be fitted to the hole.

9. The optical transceiver according to claim 1, wherein:
the chassis comprises a transceiver chassis housing a transceiver body, and a cover fixed to the transceiver chassis and covering the transceiver body, and
the cover comprises a plate spring biasing a portion except a receptacle portion of the transceiver chassis to project from the host device when the transceiver chassis is attached to the host device.

10. A method for coating the optical transceiver according to claim 7, comprising:
masking at least the projection; and
soaking a whole of the transceiver chassis in a cationic electrodeposition coating material bath to form an insulating film comprising a cationic electrodeposition coating film at the receptacle portion.

11. A method for coating the optical transceiver according to claim 8, comprising:
masking at least the hole; and
soaking a whole of the transceiver chassis in a cationic electrodeposition coating material bath to form an insulating film comprising a cationic electrodeposition coating film at the receptacle portion.

12. A method for coating the optical transceiver according to claim 9, comprising:
masking at least a portion of the transceiver chassis biased by the plate spring; and
soaking a whole of the transceiver chassis in a cationic electrodeposition coating material bath to form an insulating film comprising a cationic electrodeposition coating film at the receptacle portion.

13. A method for coating an optical transceiver attached to a host device, comprising:
masking a portion except a receptacle portion of a chassis to project from the host device when the optical transceiver is attached to the host device; and
soaking a whole of the chassis in a cationic electrodeposition coating material bath to form an insulating film comprising a cationic electrodeposition coating film at the receptacle portion.

14. The method for coating an optical transceiver according to claim 13, wherein:
the portion except the receptacle portion is masked with a silicone film.

15. The method for coating an optical transceiver according to claim 14, wherein:
the portion except the receptacle portion is soaked in a silicone liquid bath to form a silicone film at the portion except the receptacle portion.

16. A method for coating an optical transceiver attached to a host device, comprising:
attaching a tape to a receptacle portion of a chassis to project from the host device when the optical transceiver is attached to the host device;
masking a portion except the receptacle portion with a silicone film;
removing the tape; and
soaking a whole of the chassis in a cationic electrodeposition coating material bath to form an insulating film comprising a cationic electrodeposition coating film at the receptacle portion.

17. The optical transceiver according to claim 2, wherein:
the insulating film is formed by electrodeposition-coating a coating material containing a resin.

18. The optical transceiver according to claim 2, wherein:
the insulating film comprises a thickness of 5 to 50 μm.

19. The optical transceiver according to claim 3, wherein:
the insulating film comprises a thickness of 5 to 50 μm.

20. The optical transceiver according to claim 4, wherein:
the insulating film comprises a thickness of 5 to 50 μm.
